(19) United States
(12) Patent Application Publication
(10) Pub. No.: US 2024/0310336 A1
(43) Pub. Date: Sep. 19, 2024

(54) HYDROGEN FLAME IONIZATION DETECTOR, DEPOSIT REMOVAL METHOD, AND DEPOSIT REMOVAL DEVICE

(71) Applicant: SHIMADZU CORPORATION, Kyoto-shi (JP)

(72) Inventor: Yuji NAKAMA, Kyoto-shi (JP)

(21) Appl. No.: 18/606,745

(22) Filed: Mar. 15, 2024

(30) Foreign Application Priority Data
Mar. 17, 2023 (JP) 2023-043141

(51) Int. Cl. G01N 30/68; G01N 30/32

(52) U.S. Cl. CPC G01N 30/68; G01N 30/32; G01N 2030/324

(57) ABSTRACT

A hydrogen flame ionization detector brings a deposit state of a measurement target sample accumulated on a tip of a sample introduction portion to an original state in which no measurement target sample is accumulated. The hydrogen flame ionization detector includes a sample ionization unit provided with a sample introduction portion for introducing the measurement target sample, the sample ionization unit being configured to ionize the measurement target sample introduced from the sample introduction portion by using a hydrogen flame, a detection unit disposed on the sample ionization unit, the detection unit being configured to detect an electric current or light generated dues to ions that are produced by the sample ionization unit, and a removal unit configured to remove deposits of the measurement target sample accumulated on a tip of the sample introduction portion on a side of the hydrogen flame.

### CROSS-REFERENCE TO RELATED APPLICATIONS

This application claims priority under 35 U.S.C. § 119 to Japanese Patent Application No. 2023-043141 filed on Mar. 17, 2023, the entire disclosure of which is incorporated herein by reference in its entirety.

### BACKGROUND OF THE INVENTION

### Field of the Invention

The present disclosure relates to a hydrogen flame ionization detector, a deposit removal method, and a deposit removal device.

### Description of the Related Art

The following description sets forth the inventor's knowledge of the related art and problems therein and should not be construed as an admission of knowledge in the prior art.

A conventional hydrogen flame ionization detector (hereinafter referred to as “FID: Flame Ionization Detector”) is equipped with a nozzle for burning a hydrogen at the tip of the nozzle. The nozzle is equipped with a measurement target sample transfer flow path for transferring the measurement target sample to the tip of the nozzle and a hydrogen supply flow path for supplying a hydrogen as a fuel gas to the sample transfer flow path. Further, an auxiliary gas supply port for supplying air as an auxiliary gas is provided to supply the auxiliary gas for burning the hydrogen to the tip of the nozzle. The hydrogen is ignited at the tip of the nozzle to form a hydrogen flame, and the measurement target sample supplied through a flow path is burned by the hydrogen flame to be ionized, thereby producing ions, such as, e.g., CHO⁺ and C₃H₃⁺.

An ion collector is disposed on the nozzle so as to surround the hydrogen flame.

When the measurement target sample is burned by the hydrogen flame, and ions are produced, an electric current proportional to the ion production amount flows between the nozzle and the ion collector. By amplifying the electric current with an amplifier and detecting the amplified current, a response proportional to the number of carbons contained in the measurement target sample can be acquired.

### PRIOR ART DOCUMENT

### Non-Patent Document

Non-Patent Document 1: N. I. Wakayama, J. Appl. Phys, Vol. 69 (1991), pp. 2734
Non-Patent Document 2: N. I. Wakayama, Chemical Physics Letters, Vol. 185, No. 5, 6 (1991), P. 44.9.

### Problems to be Solved by the Invention

The tip of the nozzle is narrowed to about 0.1 mm to about 1 mm to prevent the hydrogen flame from entering the inside of the nozzle. Therefore, for example, when a highly concentrated measurement target sample or a measurement target sample with a high carbon number is analyzed at high frequency, deposits of the measurement target sample adhere to the nozzle tip, thereby clogging the nozzle. As a result, the flow rate of the measurement target sample to the hydrogen flame varies from a predetermined flow rate, failing to acquire normal analysis results.

### SUMMARY OF THE INVENTION

The present disclosure has been made in view of the above. The purpose of the present disclosure is to provide a hydrogen flame ionization detector, a deposit removal method, and a deposit removal device, which are capable of bringing a deposit state of a measurement target sample accumulated on the tip of the sample introduction portion close to an original state in which no measurement target sample is deposited.

### Means for Solving the Problems

A hydrogen flame ionization detector according to a first aspect of the present disclosure comprising:
a sample ionization unit provided with a sample introduction portion for introducing a measurement target sample, the sample ionization unit being configured to ionize the measurement target sample introduced from the sample introduction portion by using a hydrogen flame;
a detection unit disposed on the sample ionization unit, the detection unit being configured to detect an electric current or light generated due to ions that are produced by the sample ionization unit; and
a removal unit configured to remove deposits of the measurement target sample accumulated on a tip of the sample introduction portion on a side of the hydrogen flame.

A deposit removal method according to a second aspect of the present disclosure is a deposit removal method for a hydrogen flame ionization detector, the hydrogen flame ionization detector being provided with a sample introduction portion for introducing a measurement target sample and configured to ionize the measurement target sample introduced from the sample introduction portion by a hydrogen flame, the deposit removal method comprising:
removing deposits of the measurement target sample accumulated on a tip of the sample introduction portion on a side of the hydrogen flame.

A deposit removal device according to a third embodiment of the present disclosure is a deposit removal device for a hydrogen flame ionization detector, the hydrogen flame ionization detector being provided with a sample introduction portion for introducing a measurement target sample and configured to ionize the measurement target sample introduced from the sample introduction portion by a hydrogen flame, the deposit removal device comprising:
a removal unit configured to remove deposits of the measurement target sample accumulated on a tip of the sample introduction portion on a side of the hydrogen flame.

### Effects of the Disclosure

The technique according to the present disclosure can bring the deposition state of the measurement target sample accumulated on the tip of the sample introduction portion close to an original state in which no measurement target sample is deposited.

### BRIEF DESCRIPTION OF THE DRAWINGS

Some preferred embodiments of the present disclosure are shown by way of example, and not limitation, in the accompanying figures.

FIG. 1 is a block diagram showing one example of a hydrogen flame ionization detector according to a first embodiment.

FIG. 2A is a conceptual diagram showing one example of processing contents of an ionization processing unit.

FIG. 2B is a conceptual diagram showing one example of processing contents of a pressure increase unit.

FIG. 2C is a conceptual diagram showing one example of processing contents of a supply shut-off unit.

FIG. 3 is a flowchart showing one example of ionization processing and removal processing.

FIG. 4 is a block diagram showing one example of a hydrogen flame ionization detector according to a second embodiment.

FIG. 5 is a block diagram showing one example of a hydrogen flame ionization detector according to a third embodiment.

### DETAILED DESCRIPTION OF THE PREFERRED EMBODIMENTS

Hereinafter, referring to the attached drawings, some embodiments of the present disclosure will be described.

### First Embodiment

### (Configuration)

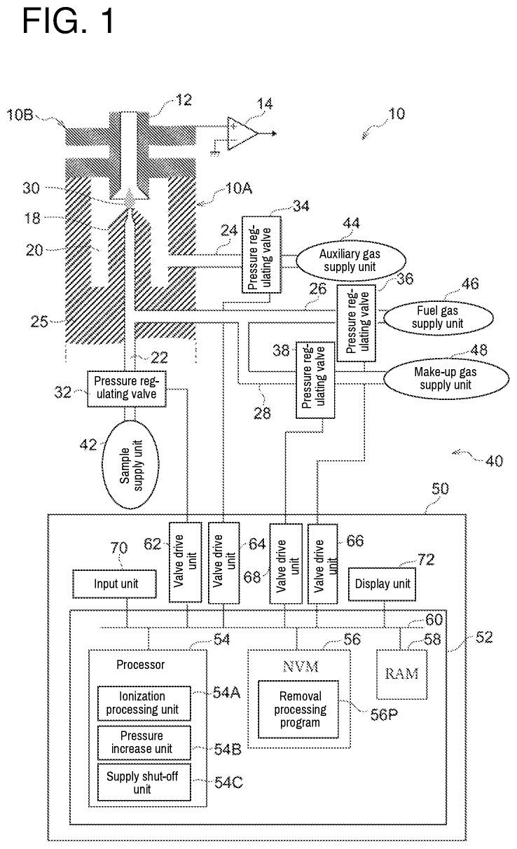

The configuration of the hydrogen flame ionization detector 10, according to a first embodiment, will be described. FIG. 1 is a block diagram showing one example of a hydrogen flame ionization detector 10 according to a first embodiment. As shown in FIG. 1, the hydrogen flame ionization detector 10 is provided with a sample ionization unit 10A, a detection unit 10B, and a removal unit 40.

The hydrogen flame ionization detector 10 is one example of the “hydrogen flame ionization detector” of the present disclosure. The removal unit 40 is one example of the “deposit removal device” of the present disclosure.

The sample ionization unit 10A has a sample introduction portion 18 for introducing a measurement target sample into a reaction space 20 defined in a base 25 and is configured to ionize the measurement target sample introduced from the sample introduction portion 18 by burning it with a hydrogen flame 30. The sample introduction portion 18 is, for example, a nozzle. Hereafter, the sample introduction portion 18 will be referred to as “nozzle 18.”

A sample supply flow path 22 and a fuel gas supply flow path 26 are connected to the nozzle 18. A make-up gas supply flow path 28 is connected to the fuel gas supply flow path 26. Note that the make-up gas supply flow path 28 may be connected to the nozzle 18 or the sample supply flow path 22.

A sample supply unit 42 is connected to the sample supply flow path 22 via a pressure regulating valve 32. A measurement target sample is supplied to the sample supply flow path 22 from the sample supply unit 42, and the supply pressure of the measurement target sample is regulated by the pressure regulating valve 32. The sample supply unit 42 is well known and, therefore, will not be described in detail, but generally includes a sample vaporization chamber for vaporizing a liquid sample, a column for separating the vaporized sample, and a carrier gas supply unit for supplying a carrier gas to feed the sample vaporized in the sample vaporization chamber into the column. The carrier gas supply unit is equipped with a cylinder and a flow rate regulator.

A fuel gas supply unit 46 is connected to the fuel gas supply flow path 26 via a pressure regulating valve 36. A fuel gas is supplied to the fuel gas supply flow path 26 from the fuel gas supply unit 46, and the supply pressure of the fuel gas is regulated by the pressure regulating valve 32. The fuel gas is hydrogen. The fuel gas supply unit 46 is a compressed hydrogen cylinder filled with hydrogen in a compressed state.

A make-up gas supply unit 48 is connected to the make-up gas supply flow path 28 via a pressure regulating valve 38. A make-up gas is supplied to the make-up gas supply flow path 28 from the make-up gas supply unit 48, and the supply pressure of the make-up gas is regulated by the pressure regulating valve 38. The make-up gas is a gas for quickly delivering the measurement target sample to the detection unit 10B and is exemplified by nitrogen or helium. The make-up gas supply unit 48 is a compressed nitrogen cylinder filled with nitrogen in a compressed state or a compressed helium cylinder filled with helium in a compressed state.

As described above, the measurement target sample and the carrier gas, the fuel gas, and the make-up gas are supplied to the nozzle 18.

An auxiliary gas supply flow path 24 is connected to the reaction space 20. The position where the auxiliary gas supply flow path 24 is connected is, for example, a middle position of the inner surface of the reaction space 20 in the vertical direction. The auxiliary gas supply flow path 24 is oriented so that the direction in which the auxiliary gas is supplied from the tip (i.e., the end connected to the inner surface of the reaction space 20) of the auxiliary gas supply flow path 24 faces the nozzle 18. An auxiliary gas supply unit 44 is connected to the auxiliary gas supply flow path 24 via a pressure regulating valve 34. The auxiliary gas is supplied to the auxiliary gas supply flow path 24 from the auxiliary gas supply unit 44, and the supply pressure of the auxiliary gas is regulated by the pressure regulating valve 34. The auxiliary gas is, for example, air. The auxiliary gas supply unit 44 is a compressed air cylinder or a compressor in which air is filled in a compressed state.

Thus, hydrogen is supplied to the reaction space 20 to which air is supplied, and the hydrogen is ignited by an igniter (not shown) to form a hydrogen flame 30. The measurement target sample supplied via the sample supply flow path 22 is fed to the hydrogen flame 30 by a carrier gas and a make-up gas. With this, the measurement target sample is burned by the hydrogen flame 30 to be ionized.

The detection unit 10B is disposed at the upper side (vertically above) of the sample ionization unit 10A. The detection unit 10B is equipped with an ion collector 12 positioned so as to surround the hydrogen flame 30 to generate an electric current proportional to the amount of ions generated and an amplifier circuit 14 for amplifying the electric current from the ion collector 12. The ion collector 12 is a cylindrical electrode and is made of stainless steel, for example. The detection unit 10B detects the electric current generated due to the ions that are produced by the sample ionization unit 10A. The electric current value is proportional to the number of carbons contained in the measurement target sample.

By the way, the opening diameter of the tip of the nozzle 18 is formed to be about 0.1 mm to about 1 mm to prevent the hydrogen flame from entering the inside. Therefore, for example, in a case where a measurement target sample with high concentration or high carbon content is analyzed (ionized) at high frequency, not all of the measurement target sample is burned (ionized) at the tip of nozzle 18 and deposited, resulting in the formation of deposits.

Here, the deposits include 1) the solidified measurement target sample, 2) the liquid measurement target sample that is about to solidify, and 3) the measurement target sample components. Since the measurement target sample adheres to the tip of the nozzle 18, the deposits are also adhered materials. In addition, all of the measurement target sample should be ionized, but some of them are not ionized and remains at the tip of the nozzle 18. Thus, the deposits are also residuals.

The region where the measurement target sample is deposited is the tip of the nozzle 18, more specifically, at least one of the inner side of the tip of the nozzle 18 and the outer side thereof.

As described above, deposits will be formed on the tip of the nozzle 18 on the hydrogen flame 30 side, resulting in clogging of the tip of the nozzle 18. This causes the flow rate of the measurement target sample into the hydrogen flame 30 to vary from a predetermined flow rate, failing to acquire normal analysis results.

Therefore, the removal unit 40 removes the deposits of the measurement target sample accumulated on the tip of the nozzle 18 on the hydrogen flame 30 side. The removal unit 40 removes the deposits accumulated at least on the inner side of the tip of the nozzle 18 and the outer side thereof. Note that the inner side of the tip of the nozzle 18 means the vicinity of the tip of the nozzle 18 on the hydrogen flame 30 side out of the sidewall of the sample supply flow path 22, which will be described later. The outer side of the tip of the nozzle 18 means the vicinity of the tip of the nozzle 18 on the hydrogen flame 30 side out of the surface in contact with the reaction space 20 of the base 25.

The removal unit 40 is equipped with a supply unit for supplying a gas to the inside of the nozzle 18 and a controller 50 for controlling the supply unit.

The supply unit is at least one of the sample supply unit (22, 32, 42), a fuel gas supply unit (26, 36, 46), and a make-up gas supply unit (28, 38, 48).

The sample supply unit (22, 32, 42) includes the sample supply flow path 22, the pressure regulating valve 32, and the sample supply unit 42.

The fuel gas supply unit (26, 36, 46) includes the fuel gas supply flow path 26, the pressure regulating valve 36, and the fuel gas supply unit 46.

The make-up gas supply unit (28, 38, 48) includes the make-up gas supply flow path 28, the pressure regulating valve 38, and the make-up gas supply unit 48.

The controller 50 includes a computer 52, an input unit 70, valve drive units 62 to 68, and a display unit 72.

The computer 52 includes a processor 54, a non-volatile memory (NVM) 56, and a random-access memory (RAM) 58. The processor 54, the NVM 56, and the RAM 58 are connected to a bus 60.

The processor 54 is a processing device including a DSP (Digital Signal Processor), a CPU (Central Processing Unit), and a GPU (Graphics Processing Unit). The DSP and the GPU operate under the control of the CPU to execute image processing. Here, a processing unit including a DSP, a CPU, and a GPU is given as an example of the processor 54, but it should be understood that this is only an example. The processor 54 may be one or more CPUs and DSPs with integrated GPU functions, one or more CPUs and DSPs with no integrated GPU function, or a TPU (Tensor Processing Unit).

The NVM 56 is a non-volatile storage device for storing various programs and parameters. As the NVM 56 is, for example, a flash memory (e.g., EEPROM (Electrically Erasable and Programmable Read Only Memory)) can be exemplified.

The RAM 58 is a memory in which information is temporarily stored and is used as a work memory by the processor 54. As the RAM 58, for example, a DRAM (Dynamic Random Access Memory) or an SRAM (Static Random Access Memory) can be exemplified.

The input unit 70, the valve drive units 62 to 68, and the display unit 72 are connected to the bus 60.

The input unit 70 is composed of a keyboard and mouse, which receive instructions from the user and output a signal indicating the received instruction to the processor 54. Further, the input unit 70 receives the value of the electric current amplified by the amplifier circuit 14 of the detection unit 10B and outputs a signal indicating the value of the received electric current to the processor 54.

The valve drive units 62 to 68 drive the pressure regulating valves 32 to 38, respectively, under the control of the computer 52.

The display unit 72 presents various information to the user under the control of the processor 54.

The NVM 56 stores the ionization processing and removal processing program 56P. The processor 54 reads out the ionization processing and removal processing program 56P from the NVM 56 and executes the read-out ionization processing and removal processing program 56P on the RAM 58 to perform the ionization and removal processing. The processor 54 operates as the ionization processing unit 54A, the pressure increase unit 54B, and the supply shut-off unit 54C according to the ionization processing and removal processing program 56P running on the RAM 58 to implement the ionization processing and removal processing. The ionization processing and removal processing is processing to control the supply unit so that the inner pressure of the nozzle 18 becomes higher than the inner pressure of the nozzle 18 set to perform the ionization processing of the measurement target sample.

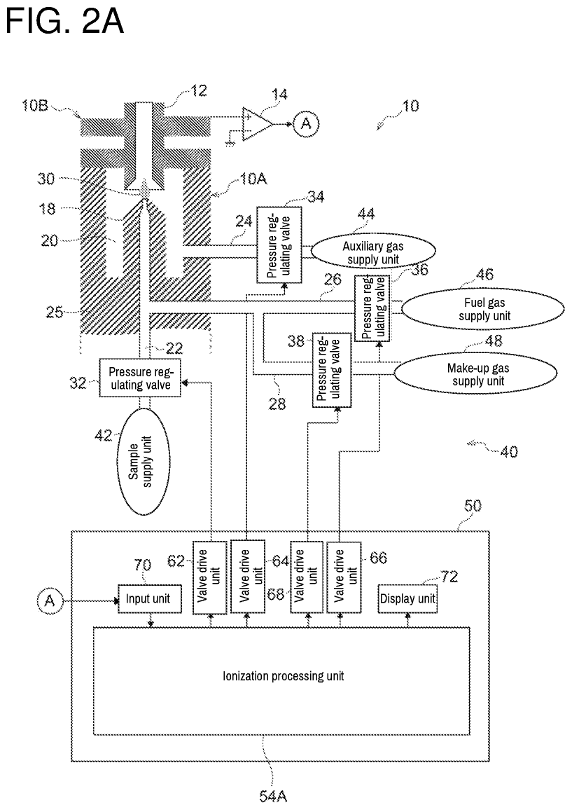

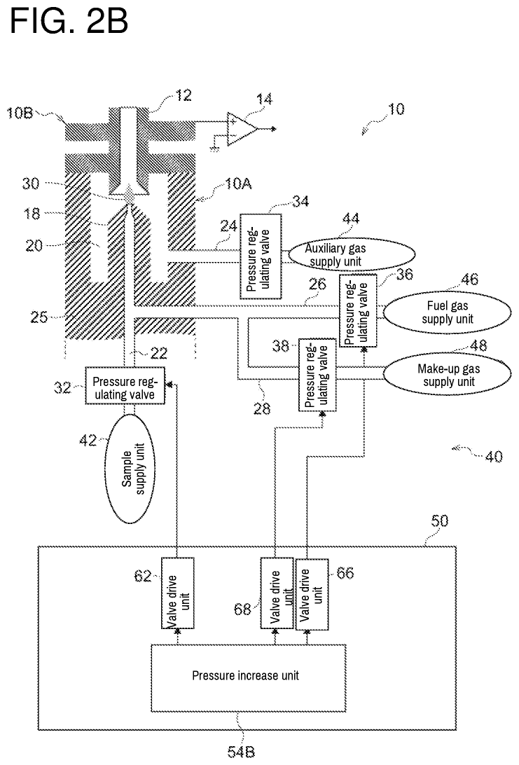

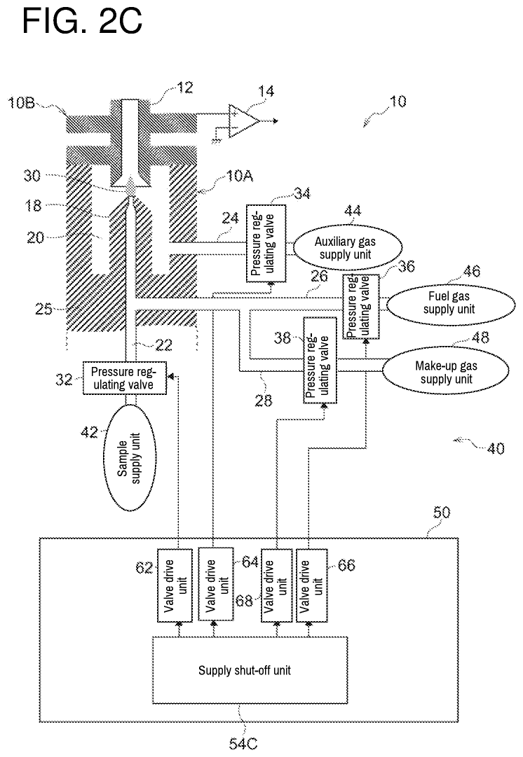

FIG. 2A is a conceptual diagram showing one example of processing contents of the ionization processing unit 54A. In FIG. 2A, the processing contents of the ionization processing unit 54A are, for example, processing for ionizing and analyzing a measurement target sample. Specifically, the ionization processing unit 54A performs the following: control of the valve drive unit 64 to regulate the pressure regulating valve 34, control of the valve drive unit 66 to regulate the pressure regulating valve 36, control of the valve drive unit 62 to regulate the pressure regulating valve 32, and control of the valve drive unit 68 to regulate the pressure regulating valve 38. With this, the air from the auxiliary gas supply unit 44 is supplied to the reaction space 20 at a predetermined pressure, the hydrogen is supplied to the reaction space 20 where the air is supplied, the hydrogen is ignited by an igniter, and a hydrogen flame 30 is formed. The measurement target sample is supplied to the hydrogen flame 30 by a carrier gas and a make-up gas.

FIG. 2B is a conceptual diagram showing one example of processing contents of the pressure increase unit 54B. The pressure increase unit 54B controls the valve drive units 62, 66, and 68 to regulate the pressure regulating valves 32, 36, and 38, respectively, to increase the pressure of each supplied gas to be larger than the pressure set at the ionization time. The pressure increase unit 54B controls all of the valve drive units 62, 66, and 68, but the present disclosure is not limited thereto. For example, the pressure increase unit 54B may control one or two of the valve drive units 62, 66, and 68 to increase the pressure of each supplied gas to be larger than the pressure set at the ionization time.

FIG. 2C is a conceptual diagram showing one example of processing contents of a supply shut-off unit 54C. The supply shut-off unit 54C controls the valve drive units 62 to 68 to regulate the pressure regulating valves 32 to 38 to shut off the supply of the respective gases.

### (Functions)

Next, the functions of the hydrogen flame ionization detector 10 according to the first embodiment will be described. In this embodiment, the ionization processing and removal processing is processing to remove the deposits accumulated on the tip of the nozzle 18 before the deposits are solidified. Specifically, the deposit removal processing is performed when a predetermined time has elapsed from the time when the processing to ionize the measurement target sample is completed. Note that the ionization processing and removal processing may be performed while the measurement target sample is being ionized and analyzed.

The ionization processing and removal processing method is one example of the “deposit removal method” according to the technology of the present disclosure.

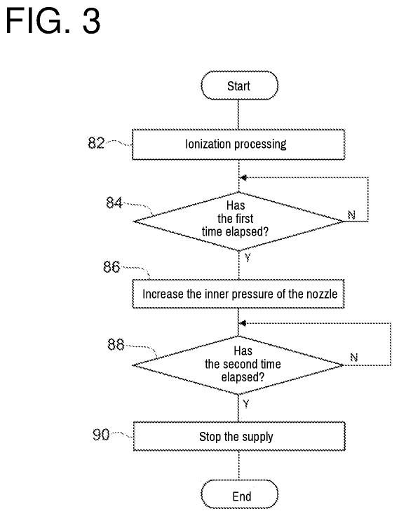

FIG. 3 is a flowchart showing one example of the ionization processing and removal processing. The ionization processing and removal processing starts when a start instruction of the ionization processing start processing is input, for example, when an ionization processing start processing button, which is not shown in the figure, is operated.

In Step 82, the ionization processing unit 54A performs the ionization processing. Specifically, as described above, the ionization processing unit 54A controls the valve drive unit 64 to regulate the pressure regulating valve 34 to supply the air from the auxiliary gas supply unit 44 to the reaction space 20 at a predetermined pressure. The ionization processing unit 54A supplies a hydrogen to the reaction space 20 where air is supplied, by controlling the valve drive unit 66 to regulate the pressure regulating valve 36, and ignites the hydrogen by an igniter to form a hydrogen flame 30. The ionization processing unit 54A controls the valve drive unit 62 to regulate the pressure regulating valve 32 and the valve drive unit 68 to regulate the pressure regulating valve 38 to thereby supply the measurement target sample to the hydrogen flame 30 with a carrier gas and a make-up gas.

With this, the measurement target sample is burned by the hydrogen flame 30 to be ionized. When ions are produced, an electric current with a magnitude proportional to the amount of ions produced flows from the ion collector 12. The electric current from the ion collector 12 is amplified by the amplifier circuit 14. The electric current value acquired by an ammeter or the like is input to the computer 52 via the input unit 70. The carbon number corresponding to the magnitude of the electric current value is analyzed and displayed on the display unit 72.

The ionization processing in Step 82 is performed for each measurement target sample.

When the ionization processing is completed for all scheduled measurement target samples, the ionization processing in Step 82 is completed, and the ionization processing and removal processing proceeds to Step 84.

In Step 84, the pressure increase unit 54B determines whether a first period of time has elapsed since the completion of the ionization processing. The first period of time is a period of time determined by experiments or other means in advance, the first period of time being shorter than the period of time required for the measurement target sample component that has not been fully ionized by the ionization processing to solidify on the tip of the nozzle 18. In the case where it is not determined that the first period of time has elapsed since the completion of the ionization processing, the pressure increase unit 54B performs the determination until a positive determination is made. In the case where it is determined that the first period of time has elapsed since the completion of the ionization processing, the ionization processing and removal processing proceeds to Step 86.

Note that the first period of time may be zero. That is, Step 84 may be omitted.

In Step 86, the pressure increase unit 54B increases the inner pressure of the nozzle 18.

Here, increasing the inner pressure of the nozzle 18 means increasing the inner pressure of the nozzle 18 to be higher than the inner pressure of the nozzle 18 set at the time of the ionization processing. More specifically, increasing the inner pressure of the nozzle 18 means regulating the inner pressure of the nozzle 18 to a predetermined pressure higher than the inner pressure of the nozzle 18 set at the time of the ionization processing to remove deposits from the inner side of the tip of the nozzle 18.

The pressure increase unit 54B regulates at least one of the pressure regulating valve 32, the pressure regulating valve 36, and the pressure regulating valve 38 so that the inner pressure of the nozzle 18 becomes a predetermined pressure which is higher than the inner pressure of the nozzle 18 set at the time of the ionization processing to remove deposits from at least the inner side of the tip of the nozzle 18 and the outer side thereof.

Setting the inner pressure of the nozzle 18 to the predetermined pressure is performed by adjusting at least one of the pressure regulating valve 32, the pressure regulating valve 36, and the pressure regulating valve 38, e.g., all of these pressure regulating valves 32, 36, and 38, to increase the flow rate of the carrier gas, the fuel gas, and the make-up gas supplied to the nozzle 18 per unit time. The increase in the flow rate of the carrier gas, the fuel gas, and the make-up gas per unit time exerts an upward force against the deposits accumulated at least on the inner side of the tip of nozzle 18 and the outer side thereof.

As described above, the processing to increase the inner pressure of the nozzle 18 in Step 86 is initiated when the first period of time (predetermined time) has elapsed from the completion of the ionization processing of the measurement target sample.

Note that when the first period of time has elapsed from the completion of the ionization processing of the measurement target sample, the temperature around the tip of the nozzle 18 is equal to the temperature at the time of the ionization processing. Therefore, the processing to increase the inner pressure of the nozzle 18 in Step 86 is performed when the temperature around the tip of the nozzle 18 is equal to the temperature at the time of the ionization processing.

In Step 88, the supply shut-off unit 54C determines whether a second period of time has elapsed since the initiation of the processing to increase the inner pressure of the nozzle 18 in Step 86. Note that the second period of time is, for example, 1 (one) second. Also note that it is not limited to 1 second but may be 1.5 seconds, 1.7 seconds, etc.

Here, the second period of time is a period of time determined by experiments or other means in advance until the removal of the deposits (i.e., components or liquid deposits) accumulated on at least one of the inner side of the tip of the nozzle 18 and the outer side thereof by the increase in pressure as described above.

In the case where it is not determined that the second period of time has elapsed since the initiation of the processing to increase the inner pressure of the nozzle 18 in Step 86, the supply shut-off unit 54C performs the determination processing until the determination becomes positive. In the case where it is determined that the second period of time has elapsed since the initiation of the processing to increase the inner pressure of the nozzle 18 in Step 86, the ionization processing and removal processing proceeds to Step 90.

Note that in Step 88, the supply shut-off unit 54C may determine whether a third period of time longer than the second period of time has elapsed.

In Step 90, the supply shut-off unit 54C regulates at least one of the pressure regulating valve 32, the pressure regulating valve 36, and the pressure regulating valve 38 so that the gas supply is shut off.

### (Effects)

As described above, the hydrogen flame ionization detector 10 of the first embodiment continuously performs the processing to set the inner pressure of the nozzle 18 to a predetermined pressure to remove deposits accumulated on at least one of the inner side of the tip of the nozzle 18 and the outer side thereof for a period of time until the removal of the deposits (i.e., components or liquid deposits).

Therefore, the hydrogen flame ionization detector 10 can remove the deposits accumulated on at least one of the inner side of the tip of the nozzle 18 and the outer side thereof by blowing them away. Therefore, the hydrogen flame ionization detector 10 can bring the deposition state of the measurement target sample accumulated on the tip of the nozzle 18 closer to the original state in which no deposits of the measurement target sample is accumulated. Therefore, it is possible to prevent deposits from being formed on the tip of the nozzle 18 on the hydrogen flame 30 side to clog the tip of the nozzle 18. Thus, the flow rate of the measurement target sample to the hydrogen flame 30 is prevented from varying from the predetermined flow rate, which in turn, makes it possible to prevent the normal analysis results from not being acquired.

Further, in the past, users shut down the hydrogen flame ionization detector every time or before the nozzle tip clogs, disassembled the hydrogen flame ionization detector, removed the nozzle, and performed the maintenance to remove deposits from the tip of the nozzle. Since the flame ionization detector had to be disassembled as described above, there was a slight difference in the performance of the flame ionization detector before and after the disassembly due to assembly errors, and the downtime of the flame ionization detector became longer. However, in this embodiment, deposits accumulated on the tip of the nozzle 18 are removed to prevent clogging, as described above. This simplifies the maintenance, shortens the downtime of the hydrogen flame ionization detector, and prevents changes in performance due to nozzle maintenance (changes in performance due to assembly errors).

Further, the hydrogen flame ionization detector 10 of the first embodiment removes deposits from the inner side of the tip of the nozzle 18 before they solidify, and therefore, the deposits can be removed before they become difficult to remove. Further, since the processing for increasing the inner pressure of the nozzle 18 is performed when the temperature around the tip of the nozzle 18 is equal to the temperature at the time of the ionization processing, the deposits can be removed before they become difficult to remove. Further, this makes it possible for the hydrogen flame ionization detector 10 to return to the service and stabilize more quickly after maintenance, resulting in shorter downtime for the hydrogen flame ionization detector 10.

Further, the supply unit of the removal unit 40 of the hydrogen flame ionization detector 10 of the first embodiment is an existing supply unit for ionizing a measurement target sample. Specifically, the supply unit of the removal unit 40 is at least one of the following: a) the sample supply flow path 22, the pressure regulating valve 32, and the sample supply unit 42; b) the fuel gas supply flow path 26, the pressure regulating valve 36, and the fuel gas supply unit 46; and c) the make-up gas supply flow path 28, the pressure regulating valve 38, and the make-up gas supply unit 48. Therefore, in the first embodiment, it is possible to remove deposits of the measurement target sample without adding any new configuration other than the existing sample supply unit for ionizing the measurement target sample. Therefore, in the first embodiment, it is possible to suppress the increase in size and cost of the hydrogen flame ionization detector 10.

Note that in the first embodiment, the measurement target sample components accumulated on the inner and outer sides of the tip of the nozzle 18 are removed before solidification, but not limited thereto. The measurement target sample components that have already solidified can be removed as well. In this case, the inner pressure of the nozzle 18 sufficient to remove the already solidified measurement target sample components and the holding time of the pressure can be determined by experiments or other means.

### Second Embodiment

### (Configuration)

Next, the configuration of the hydrogen flame ionization detector according to a second embodiment will be described. The configuration of the hydrogen flame ionization detector of the second embodiment has the same portions as the configuration of the hydrogen flame ionization detector of the first embodiment. The same portion is assigned by the same reference symbol, and the description thereof will be omitted. Only the different portions will be described.

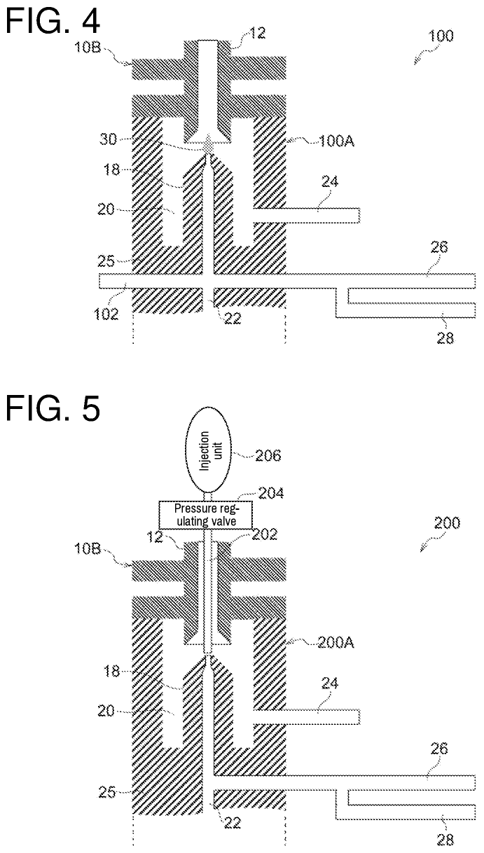

FIG. 4 is a block diagram showing one example of a hydrogen flame ionization detector 100 according to a second embodiment.

In the first embodiment, as described above, the supply unit is at least one of the following: a) the sample supply flow path 22, the pressure regulating valve 32, and the sample supply unit 42; b) the fuel gas supply flow path 26, the pressure regulating valve 36, and the fuel gas supply unit 46; and c) the make-up gas supply flow path 28, the pressure regulating valve 38, and the make-up gas supply unit 48.

In contrast, in the second embodiment, as shown in FIG. 4, the hydrogen flame ionization detector 100 differs in that a gas for increasing the inner pressure of the nozzle 18 is supplied to the inside of the nozzle 18 via another flow path 102 other than the sample supply flow path 22, the fuel gas supply flow path 26, and the make-up gas supply flow path 28.

In the second embodiment, the gas to be supplied to the inside of the nozzle 18 via the flow path 102 is not limited and can be, for example, a fuel gas or a make-up gas.

In the case where the gas to be supplied to the inside of the nozzle 18 is a fuel gas, a pressure regulating valve and a fuel gas supply unit similar to the pressure regulating valve 36 and the fuel gas supply unit 46 (see also FIG. 1) are provided to supply the fuel gas to the flow path 102. Further, in the case where the gas to be supplied to the inside of the nozzle 18 is a make-up gas, a pressure regulating valve and a make-up gas supply flow path similar to the pressure regulating valve 38 and the make-up gas supply unit 48 (see also FIG. 1) are provided to supply the make-up gas to the flow path 102.

Other than the above, the flow path 102 may be connected, for example, to the make-up gas supply flow path 28. It may be configured to provide a pressure regulating valve and a make-up gas supply similar to the pressure regulating valve 38 and the make-up gas supply unit 48 to supply a make-up gas to the flow path 102.

Further, the flow path 102 may be connected, for example, to the fuel gas supply flow path 26. It may be configured such that a pressure regulating valve and a fuel gas supply unit similar to the pressure regulating valve 36 and the fuel gas supply unit 46 are provided to supply the fuel gas to the flow path 102.

### (Functions)

In the ionization processing and removal processing of the second embodiment (Step 86 (see FIG. 3)), a gas is supplied to the inside of the nozzle 18 via the flow path 102, instead of the sample supply flow path 22, the fuel gas supply flow path 26, and the make-up gas supply flow path 28, or together with the sample supply flow path 22, the fuel gas supply flow path 26, and the make-up gas supply flow path 28, to thereby increase the inner pressure of the nozzle 18.

### (Effects)

As described above, the hydrogen flame ionization detector 100 of the second embodiment can remove deposits (i.e., components or liquid deposits) accumulated on at least one of the inner side of the tip of the nozzle 18 and the outer side thereof. Therefore, the hydrogen flame ionization detector 100 can bring the deposition state of the measurement target sample accumulated on the tip of the nozzle 18 closer to the original state in which no deposits of the measurement target sample is accumulated. Note that also in the second embodiment, the removal target is not limited to the measurement target sample components before solidification but can be a measurement target sample component that has already solidified.

Further, the hydrogen flame ionization detector 100 of the second embodiment is equipped with a gas supply unit provided separately from the gas supply unit for ionizing the measurement target sample. Therefore, it is possible to bring the deposition state of the tip of the nozzle 18 closer to the original state in which no measurement target sample is deposited by remaining the setting of the existing supply unit for ionization of the target sample to the setting for ionizing the measurement sample at the tip of the nozzle 18.

### Third Embodiment

### (Configuration)

Next, the configuration of the hydrogen flame ionization detector according to a third embodiment will be described. The configuration of the hydrogen flame ionization detector of the second embodiment has the same portions as the configuration of the hydrogen flame ionization detector of the first embodiment. The same portion is assigned by the same reference symbol and the description thereof will be omitted. Only the different portions will be described.

FIG. 5 is a block diagram showing one example of a hydrogen flame ionization detector 200 according to the third embodiment. As shown in FIG. 5, the hydrogen flame ionization detector 200 is equipped with a supply unit. The supply unit includes an injection unit 206 for injecting a gas, a pressure regulating valve 204 for regulating the pressure of the injected gas, and a guide flow path 202 positioned above the tip of the nozzle 18 to guide the gas passing through the inside of the ion collector 12 with the adjusted pressure to the outer side of the tip of the nozzle 18.

Note that the guide flow path 202 is not limited to the configuration in which it passes through the inside of the ion collector 12, and its tip is positioned above the top of the tip of the nozzle 18. For example, it may be configured such that the guide flow path 202 is inserted into an insertion hole formed in the side surface of the sample ionization unit 10A with the tip of the guide flow path 202 positioned around the tip of the nozzle 18.

### (Functions)

In the third embodiment, the ionization processing and removal processing is performed as in the first embodiment, and the supply unit (202 to 206) removes deposits by injecting a gas against the tip of the nozzle 18 from the outer side of the tip of the nozzle. The injecting of the gas against the tip of the nozzle 18 from the outer side of the tip is performed before or after the ionization processing and removal processing.

### (Effects)

As described above, the hydrogen flame ionization detector 200 of the third embodiment can remove deposits accumulated on the inner side of the tip of the nozzle 18 and the outer side thereof. Therefore, the hydrogen flame ionization detector 200 can bring the deposition state of the measurement target sample at the tip of the nozzle 18 closer to the original state in which no deposit of the measurement target sample is accumulated.

### <Modifications>

### (First Modification)

In the first embodiment to the third embodiment, the position where the auxiliary gas supply flow path 24 is connected to the reaction space 20 is, for example, in the middle of the inner surface of the reaction space 20 in the vertical direction. The auxiliary gas supply flow path 24 is oriented so that the direction in which the auxiliary gas is supplied from the tip of the auxiliary gas supply flow path 24 (i.e., the end connected to the inner surface of the reaction space 20) faces the nozzle 18. However, the technology of the present disclosure is not limited thereto.

For example, the position where the auxiliary gas supply flow path 24 is connected to the reaction space 20 may be a position corresponding to the tip of the nozzle 18 on the inner surface of the reaction space 20. The orientation of the auxiliary gas supply flow path 24 may be such that the direction in which the auxiliary gas is supplied from the tip of the auxiliary gas supply flow path 24 (i.e., the end connected to the inner surface of the reaction space 20) faces the outer side of the tip of the nozzle 18.

This allows an increase in the flow rate of the auxiliary gas per unit time to exert a horizontal force on the deposits accumulated on the tip of the nozzle 18.

As in each of the above-described embodiments, the increase in the flow rate of the carrier gas, the fuel gas, and the make-up gas per unit time exerts an upward force on the deposits accumulated on the tip of the nozzle 18.

As described above, in the first modification, a horizontal force and an upward force are exerted on the deposits accumulated on the tip of the nozzle 18. Therefore, in the first modification, it is possible to improve the removal efficiency of deposits as compared with each embodiment.

### (Second Modification)

In the first embodiment to the third embodiment, the processing for increasing the inner pressure of the nozzle 18 in Step 86 is performed from the time when the processing to ionize the measurement target sample is completed to the time when a first period of time (predetermined time) has elapsed, that is, the when the temperature around the tip of the nozzle 18 is equal to the temperature set at the time of ionizing the measurement target sample. But, the technology of the present disclosure is not limited thereto.

For example, the processing to increase the inner pressure of the nozzle 18 in Step 86 may be performed when the temperature around the tip of the nozzle 18 is at room temperature, e.g., before the ionization processing begins or after the ionization processing begins and after the time has elapsed for the temperature around the tip of the nozzle 18 to reach the room temperature. Further, in the case where the processing to increase the inner pressure of the nozzle 18 in Step 86 is performed when the temperature around the tip of the nozzle 18 is at room temperature, the temperature around the tip of the nozzle 18 may be temperature-controlled to the temperature set at the time of ionization processing by a temperature heater.

### (Third Modification)

In the processing to increase the inner pressure of the nozzle 18 in Step 86 of the first embodiment to the third embodiment, all the pressure regulating valves 32, 36, and 38 are regulated. Specifically, the flow rates of all the gases (the carrier gas, the fuel gas, and the make-up gas) per unit time supplied to the nozzle 18 are increased so that the inner pressure of the nozzle 18 is higher than the inner pressure of the nozzle 18 set at the time of the ionization processing and removal processing and to a predetermined pressure to remove the deposits inside the tip of the nozzle 18. But, the technology of the present disclosure is not limited thereto.

First, the pressure increase unit 54B switches the pressure regulating valves 32, 36, and 38 to adjust one or two pressure regulating valves to increase the flow rate of one or two gases out of the carrier gas, the fuel gas, and the make-up gas per unit time.

First, the pressure increase unit 54B adjusts the pressure regulating valve 32 to increase the flow rate of the carrier gas per unit time. Next, the pressure increase unit 54B adjusts the pressure regulating valve 36 to increase the flow rate of the fuel gas per unit time. Finally, the pressure increase unit 54B adjusts the pressure regulating valve 38 to increase the flow rate of the make-up gas per unit time.

Alternatively, the pressure increase unit 54B first adjusts the pressure regulating valves 32 and 36 to increase the flow rate of the carrier gas and that of the fuel gas per unit time. Next, the pressure increase unit 54B adjusts the pressure regulating valves 36 and 38 to increase the flow rate of the fuel gas and that of the make-up gas per unit time. Finally, the pressure increase unit 54B adjusts the pressure regulating valves 38 and 32 to increase the flow rate of the make-up gas and that of the carrier gas per unit time.

Second, the pressure increase unit 54B adjusts any one of the pressure regulating valves 32, 36, and 38 to adjust the flow rate of one of the carrier gas, the fuel gas, and the make-up gas per unit time.

For example, the pressure increase unit 54B adjusts the pressure regulating valve 32 to increase the flow rate of only the carrier gas. In this case, the pressure increase unit 54B may continuously or intermittently increase the flow rate of the carrier gas per unit time until the elapse of the second period of time.

### (Fourth Modification)

The processing to increase the inner pressure of the nozzle 18 of the first embodiment to the third embodiment is initiated once when a first period of time (predetermined time) has elapsed since the completion of the ionization processing of the measurement target sample, and is executed until the second period of time has elapsed. But, the technology of the present disclosure is not limited thereto.

For example, the user may specify or change the initiation timing of the processing in Step 86 via the input unit 70.

For example, the user may specify or change the number of times of the processing in Step 86 via the input unit 70.

Furthermore, for example, the user may specify or change the time during which the processing to increase the inner pressure unit of the nozzle 18 is to be continued via the input unit 70.

### (Fifth Modification)

The technology of the present disclosure is not limited to a hydrogen flame ionization detector (FID). For example, a gas chromatograph detector using a hydrogen flame can be a detector other than an FID, such as, e.g., a flame photometric detector (FPD) and a thermal ionization detector (FTD). Note that the flame photometric detector (FPD) detects the light generated by ionizing the measurement target sample.

### [Other Modifications]

In the above-described embodiments, an example is described in which the ionization processing and removal processing program 56P is stored in the NVM 56. However, the technology of the present disclosure is not limited thereto. For example, the ionization processing and removal processing program 56P may be stored in a portable non-transitory computer-readable storage medium, such as, e.g., an SSD, a USB memory, and a magnetic tape. The ionization processing and removal processing program 56P stored in a non-transitory storage medium is installed on the computer 52 of the hydrogen flame ionization detector 10, 100, 200. The processor 54 executes the ionization processing and removal processing according to the ionization processing and removal processing program 56P.

The ionization processing and removal processing program 56P may be stored in a storage device, such as another computer and a server device, connected to the hydrogen flame ionization detectors 10, 100, 200 via a network, and upon request of the hydrogen flame ionization detectors 10, 100, 200, the program 56P may be downloaded and installed on the hydrogen flame ionization detectors 10, 100, 200.

Note that it is not necessary to store all of the ionization processing and removal processing programs 56P in a storage device of another computer or a server device connected to the hydrogen flame ionization detector 10, 100, or 200, or in the NVM 56, but a part of the ionization processing and removal processing programs 56P may be stored in the NVM 56.

In the above-described embodiments, an example is described in which the technology of the present disclosure is realized by a software configuration, but the technology of the present disclosure is not limited thereto. A device including an ASIC (Application Specific Integrated Circuit), an FPGA (Field Programmable Gate Array), or a PLD (Programmable Logic Device) may be applied. Further, a combination of a hardware configuration and a software configuration may be used.

The following various processors can be used as a hardware resource for executing the ionization processing and removal processing described in the above embodiments. The processor is, for example, a CPU, which is a general-purpose processor that functions as a hardware resource for executing software, i.e., a program, to perform the ionization processing and removal processing.

Further, as the processor, a dedicated electronic circuit, which is a processor with a circuit configuration designed specifically to perform particular processing, such as e.g., an FPGA, a PLD, and an ASIC, can be exemplified. A memory is built into or connected to any of the processors, and the ionization processing and removal processing is performed by any of the processors using the memory.

The hardware resource for performing the ionization processing and removal processing may be composed of one of these various processors, or a combination of two or more processors of the same or different types (e.g., a combination of multiple FPGAs or a combination of a CPU and an FPGA). Further, the hardware resource for performing the ionization processing and removal processing may be a single processor.

The first example of a single processor is a configuration in which one processor is composed of a combination of one or more CPUs and software, and this processor functions as a hardware resource that performs the ionization processing and removal processing. Second, there is a configuration that uses a processor that realizes the functions of the entire system, including multiple hardware resources for performing the ionization processing and removal processing, in a single integrated circuit (IC) chip, as typified by a SoC (system-on-a-chip) or the like. Thus, the ionization processing and removal processing is realized using one or more of the various processors mentioned above as hardware resources.

Furthermore, the hardware structure of these various processors can be more specifically an electronic circuit with a combination of circuit elements such as semiconductor devices. Further, the above-described ionization processing and removal processing is only an example. Therefore, it goes without saying that unnecessary steps may be deleted, new steps may be added, or the order of processing may be switched within a scope that does not deviate from the main purpose.

The descriptions and illustrations shown above are detailed descriptions of the portions pertaining to the technology of the present disclosure and are only examples of the technology of the present disclosure. For example, the above descriptions of the configurations, functions, actions, and effects are descriptions of one example of the configurations, functions, actions, and effects of a part of the technology of the present disclosure. Therefore, it goes without saying that unnecessary portions may be deleted, and new elements may be added or substituted for the descriptions and illustrations shown above to the extent that it does not depart from the main purpose of the technology of the present disclosure. Further, in order to avoid confusion and to facilitate understanding of the parts pertaining to the technology of the present disclosure, in the descriptions and illustrations shown above, explanations concerning technical common sense, etc., that do not require particular explanation to enable implementation of the technology of the present disclosure have been omitted.

All references, patent applications, and technical standards described herein are incorporated by reference herein to the same extent that individual references, patent applications, and technical standards are specifically and individually noted as being incorporated by reference.

### [Aspects]

It would be understood by those skilled in the art that the exemplary embodiments described above are specific examples of the following aspects.

### (Item 1)

A hydrogen flame ionization detector comprising:
a sample ionization unit provided with a sample introduction portion for introducing a measurement target sample, the sample ionization unit being configured to ionize the measurement target sample introduced from the sample introduction portion by using a hydrogen flame;
a detection unit disposed on the sample ionization unit, the detection unit being configured to detect an electric current or light generated due to ions that are produced by the sample ionization unit; and
a removal unit configured to remove deposits of the measurement target sample accumulated on a tip of the sample introduction portion on a side of the hydrogen flame.

According to the hydrogen flame ionization detector as recited in the above-described Item 1, the deposition of the measurement target sample accumulated on the tip of the sample introduction portion can be brought close to the original state in which no measurement target sample is deposited.

### (Item 2)

The hydrogen flame ionization detector as recited in the above-described Item 1,
wherein the removal unit removes the deposits before the deposits solidify.

According to the hydrogen flame ionization detector as recited in Item 2, deposits can be removed before they become too difficult to remove.

### (Item 3)

The hydrogen flame ionization detector as recited in the above-described Item 2,
wherein the removal unit removes the deposits when a predetermined time has elapsed since a completion of ionization processing of the measurement target sample.

According to the hydrogen flame ionization detector as recited in Item 3, deposits can be removed before they become too difficult to remove.

### (Item 4)

The hydrogen flame ionization detector as recited in the above-described Item 1 or 2,
wherein the removal unit removes the deposits accumulated on at least one of an inner side of the tip of the sample introduction portion and an outer side thereof.

According to the hydrogen flame ionization detector as recited in the above-described Item 4, the deposition state of the measurement target sample accumulated at least one of an inner side of the tip of the sample introduction portion and an outer side thereof can be brought close to the original state in which no measurement target sample is deposited.

### (Item 5)

The hydrogen flame ionization detector as recited in the above-described Item 1 or 2,
wherein the removal unit removes the deposits by increasing an inner pressure of the sample introduction portion to be higher than the inner pressure of the sample introduction portion set to perform the ionization processing of the measurement target sample.

According to the hydrogen flame ionization detector as recited in the above-described Item 5, the deposition state of the measurement target sample accumulated on the inner side of the tip of the sample introduction portion can be brought close to the original state in which no measurement target sample is deposited.

### (Item 6)

The hydrogen flame ionization detector as recited in the above-described Item 5,
wherein the removal unit includes
a supply unit configured to supply a gas to an inside of the sample introduction portion, and
a controller configured to control the supply unit so that the inner pressure of the sample introduction portion becomes higher than the inner pressure of the sample introduction portion set to perform the ionization processing of the measurement target sample.

According to the hydrogen flame ionization detector as recited in the above-described Item 6, the deposition state of the measurement target sample accumulated on the inner side of the tip of the sample introduction portion can be brought close to the original state in which no measurement target sample is deposited.

### (Item 7)

The hydrogen flame ionization detector as recited in the above-described Item 5,
wherein the removal unit includes
a supply unit configured to supply a gas to an inside of the sample introduction portion, and
a controller configured to control the supply unit so that a flow rate of the gas supplied to the inside of the sample introduction portion per unit time becomes greater than a flow rate of the gas supplied to the inside of the sample introduction portion per unit time set to perform the ionization processing of the measurement target sample.

According to the hydrogen flame ionization detector as recited in the above-described Item 7, the deposition of the measurement target sample accumulated on the tip of the sample introduction portion can be brought close to the original state where no measurement target sample is deposited.

### (Item 8)

The hydrogen flame ionization detector as recited in the above-described Item 6 or 7,
wherein the supply unit is equipped with a gas supply unit different from the supply unit for a gas to ionize the measurement target sample.

According to the hydrogen flame ionization detector as recited in the above-described Item 8, the deposition state of the measurement target sample accumulated on the tip of the sample introduction portion can be brought close to the original state in which no measurement target sample is deposited, by setting the existing sample supply unit of the gas for ionizing the measurement target sample to the same setting as the ionization of the target sample.

### (Item 9)

The hydrogen flame ionization detector as recited in the above-described Item 6 or 7,
wherein the gas is a gas to ionize the measurement target sample.

According to the hydrogen flame ionization detector as recited in the above-described Item 9, it is possible to bring the deposition state of the measurement target sample accumulated on the tip of the sample introduction portion close to the original state in which no measurement target sample is deposited, using the existing sample supply unit for ionizing the target sample.

### (Item 10)

The hydrogen flame ionization detector as recited in the above-described Item 9,
wherein the sample ionization unit is provided with a space surrounding the tip of the sample introduction portion, and
wherein the supply unit includes at least one of
a sample supply unit configured to supply a carrier gas together with the measurement target sample to the sample introduction portion,
a fuel gas supply unit configured to supply a fuel gas to the sample introduction portion, and
a make-up gas supply unit configured to supply a make-up gas to the sample introduction portion,
wherein the hydrogen flame ionization detector further comprises an auxiliary gas supply unit to supply an auxiliary gas to the space.

According to the hydrogen flame ionization detector as recited in the above-described Item 10, it is possible to bring the deposition state of the measurement target sample accumulated on the tip of the sample introduction portion close to the original state in which no measurement target sample is deposited, using the existing sample supply unit for ionizing the target sample.

### (Item 11)

The hydrogen flame ionization detector as recited in the above-described Item 10,
wherein the auxiliary gas supply unit supplies the auxiliary gas to an outer periphery of the tip of the sample introduction portion.

According to the hydrogen flame ionization detector as recited in the above-described Item 11, the deposition state of the measurement target sample accumulated on the inner side of the tip of the sample introduction portion can be brought close to the original state in which no measurement target sample is deposited.

### (Item 12)

The hydrogen flame ionization detector as recited in the above-described Item 1 or 2,
wherein the removal unit removes the deposits by injecting a gas against the tip of the sample introduction portion from an outer side of the tip.

According to the hydrogen flame ionization detector as recited in the above-described Item 12, the deposition state of the measurement target sample accumulated on the inner side of the tip of the sample introduction portion can be brought close to the original state in which no measurement target sample is deposited.

### (Item 13)

The hydrogen flame ionization detector as recited in the above-described Item 12,
wherein the removal unit includes
an injection unit configured to inject the gas, and
a guide member configured to guide the injected gas to the tip of the sample introduction portion.

According to the hydrogen flame ionization detector as recited in the above-described Item 13, the deposition state of the measurement target sample accumulated on the inner side of the tip of the sample introduction portion can be brought close to the original state in which no measurement target sample is deposited.

### (Item 14)

The hydrogen flame ionization detector as recited in the above-described Item 13,
wherein the guide member is provided with a flow path penetrating an inside of the guide member.

According to the hydrogen flame ionization detector as recited in the above-described Item 14, the size of the hydrogen flame ionization detector can be reduced.

### (Item 15)

A deposit removal method for a hydrogen flame ionization detector, the hydrogen flame ionization detector being provided with a sample introduction portion for introducing a measurement target sample and configured to ionize the measurement target sample introduced from the sample introduction portion by a hydrogen flame, the deposit removal method comprising:
removing deposits of the measurement target sample accumulated on a tip of the sample introduction portion on a side of the hydrogen flame.

According to the deposit removal method as recited in the above-described Item 15, the deposition state of the measurement target sample accumulated on the tip of the sample introduction portion can be brought close to the original state in which no measurement target sample is deposited.

### (Item 16)

A deposit removal device for a hydrogen flame ionization detector, the hydrogen flame ionization detector being provided with a sample introduction portion for introducing a measurement target sample and configured to ionize the measurement target sample introduced from the sample introduction portion by a hydrogen flame, the deposit removal device comprising:
a removal unit configured to remove deposits of the measurement target sample accumulated on a tip of the sample introduction portion on a side of the hydrogen flame.

According to the deposit removal device as recited in the above-described Item 16, the deposition state of the measurement target sample accumulated on the tip of the sample introduction portion can be brought close to the original state in which no measurement target sample is deposited.

### (Item 17)

The hydrogen flame ionization detector as described in the above-described Item 16, wherein the removal unit removes the deposits before they solidify.

According to the hydrogen flame ionization detector as recited in Item 17, deposits can be removed before they become too difficult to remove.

### (Item 18)

The hydrogen flame ionization detector as recited in the above-described Item 17,
wherein the removal unit removes the deposits after a predetermined period of time has elapsed from a time when the ionization processing for ionizing the measurement target sample is completed.

According to the hydrogen flame ionization detector as recited in Item 18, deposits can be removed before they become too difficult to remove.

### (Item 19)

The hydrogen flame ionization detector as recited in the above-described Item 16 or 17,
wherein the removal unit removes the deposits from at least one of an inner side of the tip of the sample introduction portion and an outer side thereof.

According to the hydrogen flame ionization detector as recited in the above-described Item 19, the deposition state of the measurement target sample accumulated on at least one of an inner side of the tip of the sample introduction portion and an outer side thereof can be brought close to the original state in which no measurement target sample is deposited.

### (Item 20)

The hydrogen flame ionization detector as recited in the above-described Item 16 or 17,
wherein the removal unit removes the deposits by increasing the inner pressure of the sample introduction portion to be higher than the inner pressure of the sample introduction portion set when the ionization processing unit performs the ionization processing of the measurement target sample.

According to the hydrogen flame ionization detector as recited in the above-described Item 20, the deposition state of the measurement target sample accumulated on the inner side of the tip of the sample introduction portion can be brought close to the original state in which no measurement target sample is deposited.

### (Item 21)

The hydrogen flame ionization detector as recited in the above-described Item 20,
wherein the removal unit includes
a supply unit configured to supply a gas to an inside of the sample supply unit; and a controller configured to control the supply unit so that the inner pressure of the sample supply unit becomes higher than the inner pressure of the sample introduction portion set when the processing for ionizing the measurement target sample is performed.

According to the hydrogen flame ionization detector as recited in the above-described Item 21, the deposition state of the measurement target sample accumulated on the inner side of the tip of the sample introduction portion can be brought close to the original state in which no measurement target sample is deposited.

### (Item 22)

The hydrogen flame ionization detector as recited in the above-described Item 20,
wherein the removal unit includes
a supply unit configured to supply a gas to the inside of the sample supply unit, and
a controller configured to control the supply unit so that the flow rate of the gas per unit of time supplied to the inside of the sample supply unit becomes larger than the flow rate per of the gas supplied to the inside of the sample introduction portion unit of time set when the processing to ionize the measurement target sample.

According to the hydrogen flame ionization detector as recited in the above-described Item 22, the deposition of the measurement target sample accumulated on the tip of the sample introduction portion can be brought close to the original state in which no measurement target sample is deposited.

### (Item 23)

The hydrogen flame ionization detector as recited in the above-described Item 21 or 22,
wherein the supply unit is equipped with a gas supply unit different from the gas supply unit for ionizing the measurement target sample.

According to the hydrogen flame ionization detector as recited in the above-described Item 23, it is possible to bring the deposition state of the measurement target sample accumulated on the tip of the sample introduction portion close to the original state in which no measurement target sample is deposited, using the existing sample supply unit for ionizing the target sample.

### (Item 24)

The hydrogen flame ionization detector as recited in the above-described Item 21 or 22,
wherein the gas is a gas for ionizing the measurement target sample.

According to the hydrogen flame ionization detector as recited in the above-described Item 24, it is possible to bring the deposition state of the measurement target sample accumulated on the tip of the sample introduction portion close to the original state in which no measurement target sample is deposited, using the existing sample supply unit for ionizing the target sample.

### (Item 25)

The hydrogen flame ionization detector as recited in the above-described Item 24,
wherein the sample ionization section has a space surrounding the tip of the sample introduction portion,
wherein the supply unit includes at least one of
a sample supply unit configured to supply a carrier gas together with a measurement target sample to the sample introduction portion, and
a fuel gas supply unit configured to supply a fuel gas to the sample supply unit, and a make-up gas supply unit for supplying a make-up gas to the sample supply unit,
wherein the hydrogen flame ionization detector includes an auxiliary gas supply unit for supplying an auxiliary gas to the space.

According to the hydrogen flame ionization detector as recited in the above-described Item 25, it is possible to bring the deposition state of the measurement target sample accumulated on the tip of the sample introduction portion close to the original state in which no sample is deposited, using the existing sample supply unit for ionizing the target sample.

### (Item 26)

The hydrogen flame ionization detector as recited in the above-described Item 25,
wherein the auxiliary gas supply unit supplies the auxiliary gas to an outer periphery of the tip of the sample supply unit.

According to the hydrogen flame ionization detector as recited in the above-described Item 26, the deposition state of the measurement target sample accumulated on the inner side of the tip of the sample introduction portion can be brought close to the original state in which no measurement target sample is deposited.

### (Item 27)

The hydrogen flame ionization detector as recited in the above-described Item 16 or 17,
wherein the removal unit removes the deposits by injecting a gas against the tip of the sample introduction portion from the outer side of the tip.

According to the hydrogen flame ionization detector as recited in the above-described Item 27, the deposition state of the measurement target sample accumulated on the inner side of the tip of the sample introduction portion can be brought close to the original state in which no measurement target sample is deposited.

### (Item 28)

The hydrogen flame ionization detector as recited in the above-described Item 27,
wherein the removal unit includes
an injection unit configured to inject the gas, and
a guide member configured to guide the injected gas to the tip of the sample introduction portion.

According to the hydrogen flame ionization detector as recited in the above-described Item 28, the deposition state of the measurement target sample accumulated on the inner side of the tip of the sample introduction portion can be brought close to the original state in which no measurement target sample is deposited.

### (Item 29)

The hydrogen flame ionization detector as recited in the above-described Item 28,
wherein the guide has a flow path penetrating the inside of the detector.

According to the hydrogen flame ionization detector as recited in the above-described Item 29, the size of the hydrogen flame ionization detector can be reduced.

### DESCRIPTION OF REFERENCE SYMBOLS

18: Nozzle
10A: Sample ionization unit
10B: Detection unit
40: Removal unit
50: Controller

1. A hydrogen flame ionization detector comprising:
a sample ionization unit provided with a sample introduction portion for introducing a measurement target sample, the sample ionization unit being configured to ionize the measurement target sample introduced from the sample introduction portion by using a hydrogen flame;
a detection unit disposed on the sample ionization unit, the detection unit being configured to detect an electric current or light generated due to ions that are produced by the sample ionization unit; and
a removal unit configured to remove deposits of the measurement target sample accumulated on a tip of the sample introduction portion on a side of the hydrogen flame.

2. The hydrogen flame ionization detector as recited in claim 1,
wherein the removal unit removes the deposits before the deposits solidify.

3. The hydrogen flame ionization detector as recited in claim 2,
wherein the removal unit removes the deposits when a predetermined time has elapsed since a completion of ionization processing of the measurement target sample.

4. The hydrogen flame ionization detector as recited in claim 1,
wherein the removal unit removes the deposits accumulated on at least one of an inner side of the tip of the sample introduction portion and an outer side thereof.

5. The hydrogen flame ionization detector as recited in claim 1,
wherein the removal unit removes the deposits by increasing an inner pressure of the sample introduction portion to be higher than the inner pressure of the sample introduction portion set to perform the ionization processing of the measurement target sample.

6. The hydrogen flame ionization detector as recited in claim 5,
wherein the removal unit includes
a supply unit configured to supply a gas to an inside of the sample introduction portion, and
a controller configured to control the supply unit so that the inner pressure of the sample introduction portion becomes higher than the inner pressure of the sample introduction portion set to perform the ionization processing of the measurement target sample.

7. The hydrogen flame ionization detector as recited in claim 5,
wherein the removal unit includes
a supply unit configured to supply a gas to an inside of the sample introduction portion, and
a controller configured to control the supply unit so that a flow rate of the gas supplied to the inside of the sample introduction portion per unit time becomes greater than a flow rate of the gas supplied to the inside of the sample introduction portion per unit time set to perform the ionization processing of the measurement target sample.

8. The hydrogen flame ionization detector as recited in claim 6,
wherein the supply unit is equipped with a gas supply unit different from the supply unit for a gas to ionize the measurement target sample.

9. The hydrogen flame ionization detector as recited in claim 6,
wherein the gas is a gas to ionize the measurement target sample.

10. The hydrogen flame ionization detector as recited in claim 9,
wherein the sample ionization unit is provided with a space surrounding the tip of the sample introduction portion, and
wherein the supply unit includes at least one of
a sample supply unit configured to supply a carrier gas together with the measurement target sample to the sample introduction portion,
a fuel gas supply unit configured to supply a fuel gas to the sample introduction portion, and
a make-up gas supply unit configured to supply a make-up gas to the sample introduction portion,
wherein the hydrogen flame ionization detector further comprises an auxiliary gas supply unit to supply an auxiliary gas to the space.

11. The hydrogen flame ionization detector as recited in claim 10,
wherein the auxiliary gas supply unit supplies the auxiliary gas to an outer periphery of the tip of the sample introduction portion.

12. The hydrogen flame ionization detector as recited in claim 1,
wherein the removal unit removes the deposits by injecting a gas against the tip of the sample introduction portion from an outer side of the tip.

13. The hydrogen flame ionization detector as recited in claim 12,
wherein the removal unit includes
an injection unit configured to inject the gas, and
a guide member configured to guide the injected gas to the tip of the sample introduction portion.

14. The hydrogen flame ionization detector as recited in claim 13,
wherein the guide member is provided with a flow path penetrating an inside of the guide member.

15. A deposit removal method for a hydrogen flame ionization detector, the hydrogen flame ionization detector being provided with a sample introduction portion for introducing a measurement target sample and configured to ionize the measurement target sample introduced from the sample introduction portion by a hydrogen flame, the deposit removal method comprising:
removing deposits of the measurement target sample accumulated on a tip of the sample introduction portion on a side of the hydrogen flame.

16. A deposit removal device for a hydrogen flame ionization detector, the hydrogen flame ionization detector being provided with a sample introduction portion for introducing a measurement target sample and configured to ionize the measurement target sample introduced from the sample introduction portion by a hydrogen flame, the deposit removal device comprising:
a removal unit configured to remove deposits of the measurement target sample accumulated on a tip of the sample introduction portion on a side of the hydrogen flame.
